(19) United States
(12) Patent Application Publication
(10) Pub. No.: US 2026/0244190 A1
(43) Pub. Date: Aug. 20, 2026

(54) SYSTEMS, METHODS, AND MEDIA FOR EMERGENCY WATER QUALITY MANAGEMENT IN SMART CITY PIPE NETWORKS BASED ON INTERNET OF THINGS LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/641,502

(22) Filed: Apr. 7, 2026

(30) Foreign Application Priority Data
Mar. 9, 2026 (CN) 202610284500.5

(51) Int. Cl. G05B 19/416

(52) U.S. Cl. CPC G05B 19/416; G05B 2219/45006

(57) ABSTRACT

Provided is a system for emergency water quality management in a smart city pipe network based on an IoT large model, including the emergency water quality management platform configured to: in response to a water quality contamination point occurring within one or more pipe network regions, determine a critical contamination region based on a contamination probability of the one or more pipe network regions and the water quality contamination point; determine a contamination source region based on water quality monitoring data, hydraulic monitoring data, and pipe network data of a plurality of monitoring points within the critical contamination region; determine a plurality of first valves based on source hydraulic data of the contamination source region; and generate a first valve control instruction based on the plurality of first valves, and control the plurality of first valves within the contamination source region to close based on the first valve control instruction.

### CROSS-REFERENCE TO RELATED APPLICATIONS

This application claims priority to Chinese Patent Application No. 202610284500.5, filed on March 9, 2026, the contents of which are hereby incorporated by reference to its entirety.

### TECHNICAL FIELD

The present disclosure relates to the technical field of Internet of Things large models, and in particular to a system, a method, and a non-transitory computer-readable storage medium for emergency water quality management in a smart city pipe network based on an Internet of Things (IoT) large model.

### BACKGROUND

With the accelerated urbanization process, a water supply pipe network becomes increasingly large-scale and complex. However, problems such as pipe network aging and design defects cause secondary contamination to easily occur in old residential communities and pipe network terminal portions, such as pipeline corrosion, microbial breeding, and backflow of external contamination. Such secondary contamination not only causes water quality abnormalities such as a sharp decrease in residual chlorine and an increase in turbidity, but also threatens safety and health of drinking water of residents. The conventional water supply management technology has a problem that monitoring, analysis, and control are disconnected from each other. Most systems only provide isolated water quality early warning and lack a deep analysis capability, and the isolated water quality early warning is unable to effectively integrate different monitoring data and pipe network operation information. When a water quality abnormality occurs, the water quality abnormality may only be handled manually in a slow and extensive post-event manner, and a contamination source cannot be traced quickly and accurately and effective prevention and control cannot be performed, which has become a major challenge for urban water supply safety assurance.

Therefore, it is necessary to provide a system, a method, and a non-transitory computer-readable storage medium for emergency water quality management in a smart city pipe network based on an IoT large model, so as to improve comprehensiveness, timeliness, and effectiveness of urban pipe network water quality management.

### SUMMARY

One or more embodiments of the present disclosure provide a system for emergency water quality management in a smart city pipe network based on an IoT large model. The system comprises an emergency water quality management platform, wherein the emergency water quality management platform is configured to: in response to a water quality contamination point occurring within one or more pipe network regions, determine a critical contamination region based on a contamination probability of the one or more pipe network regions and the water quality contamination point; determine a contamination source region based on water quality monitoring data, hydraulic monitoring data, and pipe network data of a plurality of monitoring points within the critical contamination region; determine a plurality of first valves based on source hydraulic data of the contamination source region, wherein the plurality of first valves are downstream valves on pipe sections at connections between the contamination source region and other pipe network regions; and generate a first valve control instruction based on the plurality of first valves, and control the plurality of first valves within the contamination source region to close based on the first valve control instruction.

One or more embodiments of the present disclosure provide a method for emergency water quality management in a smart city pipe network. The method is implemented by an emergency water quality management platform of a system for emergency water quality management in a smart city pipe network based on an IoT large model. The method comprises: in response to a water quality contamination point occurring within one or more pipe network regions, determining a critical contamination region based on a contamination probability of the one or more pipe network regions and the water quality contamination point; determining a contamination source region based on water quality monitoring data, hydraulic monitoring data, and pipe network data of a plurality of monitoring points within the critical contamination region, determining a plurality of first valves based on source hydraulic data of the contamination source region, wherein the plurality of first valves are downstream valves on pipe sections at connections between the contamination source region and other pipe network regions, generating a first valve control instruction based on the plurality of first valves, and controlling the plurality of first valves within the contamination source region to close based on the first valve control instruction.

One or more embodiments of the present disclosure provide a non-transitory computer-readable storage medium, storing computer instructions, wherein when a computer reads the computer instructions stored in the non-transitory computer-readable storage medium, the computer is configured to perform the above method.

### BRIEF DESCRIPTION OF THE DRAWINGS

The present disclosure will be further described by way of exemplary embodiments, and the exemplary embodiments will be described in detail with reference to the accompanying drawings. These embodiments are not restrictive. In the exemplary embodiments, same reference numerals indicate same structures, wherein:

FIG. 1 is a schematic diagram illustrating an exemplary platform architecture of a system for emergency water quality management in a smart city pipe network based on an IoT large model according to some embodiments of the present disclosure;

FIG. 2 is a flowchart illustrating an exemplary process of a method for emergency water quality management in a smart city pipe network according to some embodiments of the present disclosure;

FIG. 3 is a schematic diagram illustrating an exemplary process for determining a contamination source region and one or more future diffusion paths based on a hydraulic model according to some embodiments of the present disclosure; and

FIG. 4 is a schematic diagram illustrating an exemplary process for determining a blocking effect based on a loss assessment model according to some embodiments of the present disclosure.

### DETAILED DESCRIPTION

To illustrate the technical solutions in the embodiments of the present disclosure more clearly, the following briefly introduces the accompanying drawings required for describing the embodiments. The accompanying drawings do not represent all possible embodiments.

Unless the context clearly indicates otherwise, the terms "a," "an," "one," and/or "the" are not intended to be singular only and may also include the plural. In general, the terms "include" and "comprise" merely indicate the inclusion of explicitly identified steps and elements, and these steps and elements do not constitute an exclusive list. The method or device may also include other steps or elements.

In the embodiments of the present disclosure, when describing operations performed step by step, unless otherwise specified, the order of the steps is adjustable, steps may be omitted, and other steps may also be included during the operation.

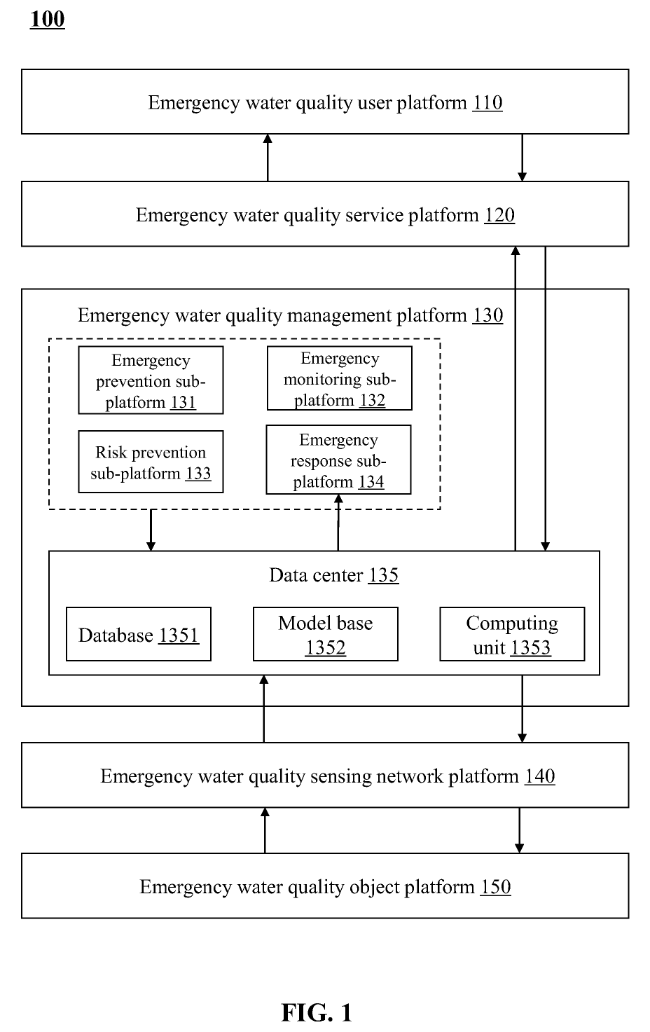

FIG. 1 is a schematic diagram illustrating an exemplary platform architecture of a system for emergency water quality management in a smart city pipe network based on an Internet of Things (IoT) large model according to some embodiments of the present disclosure.

The system for emergency water quality management in a smart city pipe network based on an IoT large model refers to a system constituted by an IoT model architecture configured to enable efficient operation of a large amount of data. In the system, a plurality of artificial intelligence models may be integrated, including a neural network model, a machine learning model, a large language model, or the like, so as to facilitate sensing and processing of data.

As shown in FIG. 1, the system for emergency water quality management in a smart city pipe network based on an IoT large model 100 (hereinafter referred to as the system 100) includes an emergency water quality user platform 110, an emergency water quality service platform 120, an emergency water quality management platform 130, an emergency water quality sensing network platform 140, and an emergency water quality object platform 150.

The emergency water quality user platform 110 is a platform for performing information interaction with a user. For example, the emergency water quality user platform 110 may be configured as a user terminal, including a mobile phone, a computer, an in-vehicle terminal, a monitoring terminal, or the like. The user terminal may include an interaction interface and a display interface.

In some embodiments, the emergency water quality user platform 110 may perform data interaction with an emergency water quality management platform 130 through an emergency water quality service platform 120. For example, user demands (e.g., monitoring demands for pipe network water quality) and emergency control instructions are sent to the emergency water quality management platform 130. As another example, the monitored water quality data is obtained from the emergency water quality management platform 130.

The emergency water quality service platform 120 is a platform configured for service communication and processing and storing service data.

In some embodiments, the emergency water quality service platform 120 may be configured as a single server or a server group. The server group may be centralized or distributed. For example, the server group may constitute a distributed system. In some embodiments, a server may be local or remote.

In some embodiments, the emergency water quality service platform 120 may further include a database or a storage device.

In some embodiments, the emergency water quality service platform 120 may interact with the emergency water quality user platform 110 and the emergency water quality management platform 130 to perform data exchange.

The emergency water quality management platform 130 is a platform configured to perform emergency water quality management. In some embodiments, the emergency water quality management platform 130 is configured as a processor, such as a central processing unit (CPU), a microcontroller, an embedded processor (EP), a graphics processing unit (GPU), or any combination thereof.

As shown in FIG. 1, the emergency water quality management platform 130 includes a plurality of management sub-platforms and a data center 135. The management sub-platforms include an emergency prevention sub-platform 131, an emergency monitoring sub-platform 132, a risk prevention sub-platform 133, and an emergency response sub-platform 134.

The emergency prevention sub-platform 131 is configured to perform water quality monitoring and prevention of contamination problems. For example, the emergency prevention sub-platform 131 is configured to publicize water quality protection knowledge, water quality contamination knowledge, prevention measures, or the like to a user.

The emergency monitoring sub-platform 132 is configured to control a monitoring device to monitor water quality, hydraulics, or the like of a pipe network region. The monitoring device may include a residual chlorine sensor, a turbidity sensor, an ultraviolet absorption sensor, and a pipe network monitoring device (e.g., a water volume monitor, a flow velocity monitor, or the like).

The risk prevention sub-platform 133 is configured to, in response to a water quality contamination risk existing, perform emergency prevention operations. For example, the risk prevention sub-platform 133 is configured to control the monitoring device to continuously monitor water quality at a high density, and send early warning information to a water quality supervision user.

The emergency response sub-platform 134 is configured to, in response to a water quality contamination event occurring, perform emergency handling operations. For example, the emergency response sub-platform 134 is configured to control a valve of a pipe network corresponding to a pipe network region affected by water quality contamination to close, and dispatch water resources to a user affected by water quality contamination.

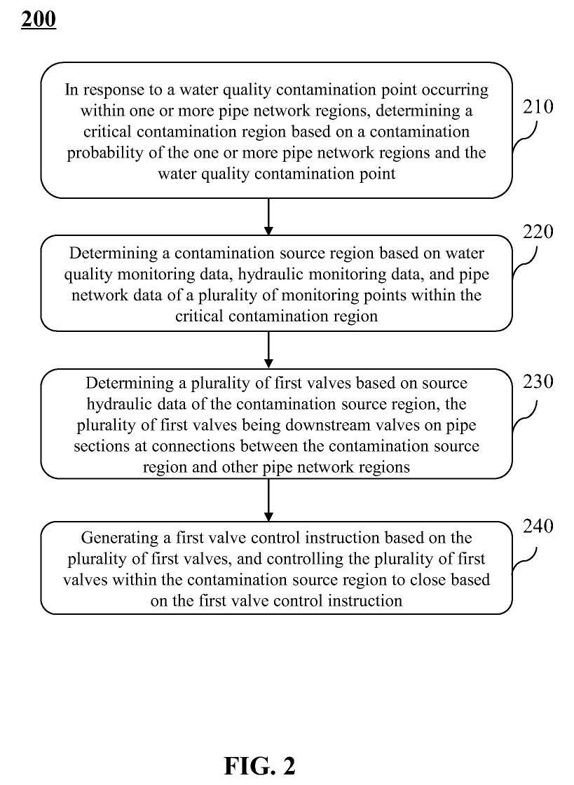

More descriptions regarding the emergency water quality management platform 130 may be found in other contents of the present disclosure (e.g., descriptions in connection with FIGS. 2-4).

In some embodiments, each of the management sub-platforms may communicate with the data center 135, so as to perform data acquisition tasks and/or data processing tasks based on corresponding instructions.

The data center 135 includes a database 1351, a model base 1352, and a computing unit 1353. The database 1351 stores data obtained by the emergency water quality management platform 130 through interaction with other platforms and/or processing results or instructions generated by the emergency water quality management platform 130 by processing data, etc. The model base 1352 stores a plurality of models required for performing emergency water quality early warning in a smart city, such as a neural network model, a machine learning model, a large language model, or the like. The computing unit 1353 performs data processing, and may invoke a corresponding data processing model from the model base 1352 and obtain corresponding data to be processed from the database 1351.

In some embodiments, the emergency water quality management platform 130 may perform data interaction with the emergency water quality service platform 120 and/or the emergency water quality sensing network platform 140 through the data center 135.

The emergency water quality sensing network platform 140 is a sensing communication platform configured to upload sensing information and transmit control information. For example, the emergency water quality sensing network platform 140 may be configured as a gateway, a data interface, or the like. The emergency water quality sensing network platform 140 may upload water quality data and hydraulic data to the emergency water quality management platform 130, and transmit water quality monitoring related instructions to the emergency water quality object platform 150.

The emergency water quality object platform 150 is a platform configured for information sensing and task execution. For example, the emergency water quality object platform 150 may be configured as a monitoring device (e.g., including a residual chlorine sensor, a turbidity sensor, an ultraviolet absorption sensor, and a pipe network monitoring device), a valve controller, an inspection robot, a drain valve, a pipe flushing device, and a disinfection device, or the like.

In some embodiments of the present disclosure, through the IoT large model architecture provided by the system 100, efficient operation of a large amount of data can be enabled. A closed loop for data acquisition, processing, and execution can be formed among the platforms, so as to improve efficiency and reliability of data processing. A plurality of artificial intelligence models are integrated into the large model architecture, so as to further facilitate sensing and processing of data, and improve timeliness and effectiveness of emergency water quality supervision.

It should be noted that the above description of the system 100 is merely for convenience and does not limit the scope of the present disclosure to the cited embodiments. It should be noted that the above descriptions of the system 100 are merely for convenience and do not limit the present disclosure to the scope of the referenced embodiments.

Some embodiments of the present disclosure provide a method for emergency water quality management in a smart city pipe network, and the method may be implemented by the emergency water quality management platform of the system for emergency water quality management in a smart city pipe network based on an IoT large model.

FIG. 2 is a flowchart illustrating an exemplary process of a method for emergency water quality management in a smart city pipe network according to some embodiments of the present disclosure. As shown in FIG. 2, the process 200 includes steps 210-240.

In step 210, in response to a water quality contamination point occurring within one or more pipe network regions, a critical contamination region is determined based on a contamination probability of the one or more pipe network regions and the water quality contamination point.

The pipe network region refers to a region divided in a hydraulic transportation pipe network system. Dividing the pipe network region facilitates monitoring and management of pipe network water quality. For example, the pipe network region includes different management regions or monitoring regions of an urban water supply pipe network.

In some embodiments, the pipe network region may be determined based on a geographic location, an administrative division, an actual monitoring demand, or the like.

The water quality contamination point refers to a position or a region in the pipe network where water quality is abnormal and does not meet a preset standard due to contamination or the like. For example, the water quality contamination point includes a position or a region where a water quality index such as residual chlorine content, turbidity, or total organic carbon (TOC) exceeds a contamination threshold.

In some embodiments, the water quality contamination point may be determined through monitoring data of a plurality of monitoring points in the pipe network region.

The monitoring point refers to a key node or a position arranged in the pipe network region and configured to monitor information such as water quality and hydraulics, or the like. The monitoring point may be provided with a residual chlorine sensor, a turbidity sensor, and an ultraviolet absorption sensor, and the residual chlorine sensor, the turbidity sensor, and the ultraviolet absorption sensor are configured to obtain, in real time, water quality indexes such as residual chlorine content, turbidity, and TOC in water flow at each monitoring point.

In some embodiments, a processor may determine whether each water quality index in the water quality monitoring data of each of the plurality of monitoring points exceeds a corresponding contamination threshold. In response to determining that any water quality index of any monitoring point exceeds the corresponding contamination threshold, the pipe network region may include the water quality contamination point. In some embodiments, different pipe network regions may be provided with different contamination thresholds, and the contamination threshold of each pipe network region is negatively correlated with a historical contamination probability of the pipe network region.

The contamination probability refers to a possibility that a water quality contamination event occurs in a pipe network region. The contamination probability may be represented by a probability value.

In some embodiments, the contamination probability may be evaluated and determined based on historical water quality data, pipe material data, or a real-time water quality data sequence of a pipe network region.

In some embodiments, a processor may determine a contamination probability of each monitoring point based on the water quality monitoring data of each monitoring point in the pipe network region through referring to a first preset table. Then, a mean value of the contamination probabilities of the monitoring points may be determined as the contamination probability of a corresponding pipe network region.

The water quality monitoring data refers to data monitored and obtained at a monitoring point, which reflects a water body quality condition. For example, the water quality monitoring data includes water quality indexes such as residual chlorine content, turbidity, and TOC in a water body.

The first preset table includes residual chlorine content, turbidity, TOC, and a mapping relationship between the residual chlorine content, the turbidity, the TOC, and a corresponding contamination probability. The first preset table may be constructed based on historical data. For example, historical water quality data (including residual chlorine content, turbidity, and TOC) is clustered, a residual chlorine content range, a turbidity range, and a TOC range in each cluster are used as a set of historical water quality data in the first preset table, and a ratio of a count of clustering vectors in the cluster in which water quality contamination occurs after a preset time period to a count of all clustering vectors in the cluster is used as a reference contamination probability corresponding to the set.

In some embodiments, the contamination probability is determined by the following process: at each preset interval, a water quality data sequence of one or more pipe network regions in the pipe network is obtained; and the contamination probability of the one or more pipe network regions is determined based on the water quality data sequence and pipe material data.

The preset interval refers to a time interval for obtaining the water quality data sequence. The preset interval may be preset. For example, the preset interval may be 3 minutes or 5 minutes.

The water quality data sequence refers to a set of water quality monitoring data collected in sequence within a period of time. For example, the water quality data sequence is a set in which real-time water quality monitoring data, such as residual chlorine content, turbidity, and TOC at a plurality of time points within the preset interval, are arranged in chronological order.

In some embodiments, a processor controls a monitoring device to collect the water quality monitoring data of each monitoring point according to the preset interval or obtains stored water quality monitoring data, and the water quality monitoring data of each monitoring point is arranged in sequence to obtain a corresponding water quality data sequence.

In some embodiments, the contamination probability of one or more pipe network regions may be evaluated by the processor based on the water quality data sequence and the pipe material data through a clustering algorithm.

The pipe material data refers to data describing material characteristics and a health condition of pipelines in the pipe network. For example, the pipe material data includes a material type of a pipe wall, service years, and a pipe thickness.

In some embodiments, a processor constructs clustering objects to be clustered, and the clustering objects to be clustered include historical clustering vectors and a target vector. For example, a plurality of historical water quality data sequences of different pipe network regions are obtained as a plurality of historical clustering vectors, and the water quality data sequence of a pipe network region to be currently evaluated is determined as the target vector. Each historical clustering vector is associated with a label, and the label indicates whether the water quality contamination point occurs in the region within a preset time period after a historical time corresponding to the historical clustering vector. The label may be binary 0 or 1 indicating whether the water quality contamination point occurs, or a value indicating a contamination severity.

n some embodiments, the historical clustering vector may be concatenated with the pipe material data. For example, the pipe material data may be extracted as a feature vector, and the feature vector is concatenated with the historical clustering vector for clustering analysis. The pipe material data is used to measure a corrosion risk or an aging degree of a pipeline, and the pipe material data combined with the historical water quality data sequence may form a more comprehensive historical clustering vector.

In some embodiments, the processor performs clustering processing on the plurality of historical clustering vectors and the target vector to determine a plurality of clusters. A clustering algorithm includes, but is not limited to, K-Means clustering, DBSCAN, a Gaussian mixture model (GMM), or hierarchical clustering. The processor records the cluster in which the target vector is located as a target cluster.

In some embodiments, the processor counts a plurality of historical clustering vectors in the target cluster labeled as “the water quality contamination point occurs” and uses a ratio of the count to a count of all historical clustering vectors in the target cluster as the contamination probability corresponding to the target vector.

In some embodiments, the processor may further determine the contamination probability in other manners, such as by a trained machine learning model, in combination with an expert experience system, by a rule-based technology, or the like.

In some embodiments of the present disclosure, by obtaining the water quality data sequence of each pipe network region at each preset interval and in combination with the pipe material data, the contamination probability of each pipe network region can be dynamically evaluated, so as to enable dynamic and proactive monitoring of potential contamination risks of the pipe network. Incorporating the pipe material data into evaluation considers that aging or corrosion of pipelines is an important indicator of a potential contamination source and mitigates a lag or incompleteness that may exist in using only water quality data.

In some embodiments, the processor determines the contamination probability of the one or more pipe network regions based on the water quality data sequence and the pipe material data, including: determining a dynamic anomaly index and a static anomaly index of the one or more pipe network regions based on the water quality data sequence and the pipe material data; and determining the contamination probability of the one or more pipe network regions based on the dynamic anomaly index and the static anomaly index.

The dynamic anomaly index refers to an index reflecting an abnormal degree of the water quality monitoring data in the pipe network. For example, the dynamic anomaly index includes an abnormal degree varying with time of the water quality data sequence.

The static anomaly index refers to an index reflecting an abnormal degree of a structural condition or a material health condition of a pipeline of the pipe network. For example, the static anomaly index includes an index reflecting a corrosion susceptibility degree or an aging degree of a pipeline based on information such as a material type of a pipe wall, service years, and a pipe thickness.

In some embodiments, the processor determines the dynamic anomaly index based on the water quality data sequence through a clustering analysis method. For example, the processor obtains a plurality of sets of historical water quality data sequences of different pipe network regions, clusters the current water quality data sequence with the historical water quality data sequences, and determines a cluster in which the current water quality data sequence is located. A count of the plurality of historical water quality data sequences in the cluster for which the water quality contamination point occurs within a preset time period after corresponding historical times is determined, and a ratio of the count to a total count of water quality data sequences in the cluster is determined as the dynamic anomaly index.

In some embodiments, the dynamic anomaly index may be determined in other manners, such as by querying a historical database or an expert base.

In some embodiments, the processor determines a corrosion susceptibility degree of a pipeline based on the pipe material data through querying a static index preset table. The static index preset table may include a plurality of sets of pipe material data and corresponding corrosion susceptibility degree scores. The static index preset table is constructed based on historical pipe material data and corresponding historical corrosion degree data.

In some embodiments, the processor determines, from the pipe material data, a thickness difference between a pipe wall thickness and a standard thickness, and a year difference between service years and standard service years. A weighted sum of the thickness difference, the year difference, and the corrosion susceptibility degree is determined as the static anomaly index. Before performing weighted summation, the thickness difference, the year difference, and the corrosion susceptibility degree may be normalized, so as to convert data in different dimensions to a unified scale. Normalization algorithms include Min-Max normalization, Z-score normalization, L2 norm normalization, or the like. Weighting coefficients may be set based on experience, and the weighting coefficients may also be determined based on historical pipeline failure data through regression analysis or a machine learning technology, so that weighted summation more accurately characterizes the static anomaly index.

In some embodiments, the static anomaly index may also be determined in a plurality of other manners. For example, internal defect data of a pipeline is obtained through non-destructive testing technologies such as ultrasonic testing and magnetic particle inspection, and the static anomaly index is comprehensively evaluated based on the internal defect data.

In some embodiments, the processor normalizes the dynamic anomaly index and the static anomaly index, and performs weighted summation to obtain the contamination probability. Normalization methods include Min-Max normalization, Z-score normalization, or the like. In some embodiments, weighting coefficients may be set according to an emphasis degree on water quality abnormality and pipeline abnormality. For example, in a scenario with a high requirement for real-time water quality, a higher weight may be assigned to the dynamic anomaly index.

In some embodiments, the contamination probability may also be determined in various other manners, including, but not limited to, fuzzy logic inference or probability inference based on a Bayesian network.

In some embodiments of the present disclosure, by decomposing evaluation of a pipe network water quality contamination risk into two dimensions of a dynamic anomaly index and a static anomaly index, accuracy and reliability of contamination probability evaluation are improved. The dynamic anomaly index reflects changes of the water quality data in real time and captures an immediate contamination risk. The static anomaly index characterizes a material condition and a health condition of a pipeline and reveals a potential structural risk of the pipe network. By comprehensively incorporating information of the two dimensions, an evaluation result of the contamination probability becomes more comprehensive and accurate.

The critical contamination region refers to a pipe network region in which water quality contamination has currently occurred or a contamination probability exceeds an allowable condition. For example, the critical contamination region includes a pipe network region in which the water quality contamination point occurs, or a pipe network region with a contamination probability greater than a contamination probability threshold and a distance to the water quality contamination point less than a preset distance threshold.

In some embodiments, the processor determines a high contamination risk region in which a water quality contamination point occurs and a high contamination risk region with a distance to each water quality contamination point less than the preset distance threshold as the critical contamination region. The high contamination risk region refers to a pipe network region with a contamination probability greater than a preset risk threshold. The preset risk threshold and the preset distance threshold may be set based on experience. For example, the preset risk threshold and the preset distance threshold are comprehensively determined based on factors such as analysis of historical contamination events, a pipe network topology structure, and a water flow propagation speed.

In some embodiments, the critical contamination region may also be determined in other manners. For example, a region in which a monitoring point with a contamination degree higher than a threshold in the water quality monitoring data of all monitoring points is located is determined as the critical contamination region.

In step 220, a contamination source region is determined based on water quality monitoring data, hydraulic monitoring data, and pipe network data of a plurality of monitoring points within the critical contamination region.

The hydraulic monitoring data refers to data obtained in real time at a monitoring point, which reflects a motion state of a water body. For example, the hydraulic monitoring data includes a flow direction and a flow velocity of water flow in a pipeline. The hydraulic monitoring data may be obtained through a monitoring device such as a flow velocity monitor.

The pipe network data refers to data describing a topology structure and physical characteristics of a pipe network system. For example, the pipe network data includes information such as connection relationships of pipe sections in the pipe network, a pipe length, a diameter, a trend, a connection point, or the like. The pipe network data may be obtained through pipe network construction layout data, or the like.

The contamination source region refers to a pipe network region in the pipe network system where water quality contamination initially enters or is generated. For example, the contamination source region is a pipe network region in which water quality contamination is monitored earliest.

In some embodiments, for each critical contamination region, the processor determines an upstream-most region of the critical contamination region based on flow direction information of water flow in the critical contamination region and the connection relationships of pipe sections in the pipe network. Then, the processor determines a plurality of upstream-most regions corresponding to a plurality of critical contamination regions as the contamination source region.

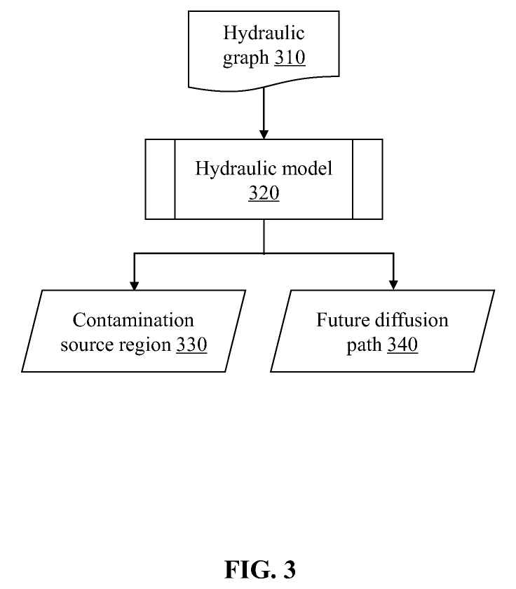

In some embodiments, the processor determines the contamination source region through a hydraulic model. More descriptions may be found elsewhere in the present disclosure (e.g., FIG. 3 and related descriptions thereof).

In some embodiments, the contamination source region may also be determined in other manners. For example, a contamination start point or a contamination start region is determined through a traceability sensor arranged in the pipe network or a tracer tracking technology.

In step 230, a plurality of first valves are determined based on source hydraulic data of the contamination source region, wherein the plurality of first valves are downstream valves on pipe sections at connections between the contamination source region and other pipe network regions.

The source hydraulic data refers to hydraulic monitoring data within the contamination source region or within a nearby range of the contamination source region. For example, the source hydraulic data includes a flow direction and a flow velocity of water flow in the contamination source region. More descriptions regarding the hydraulic monitoring data may be found in the related descriptions of step 220.

The first valve refers to a valve configured to control water flow in the contamination source region from diffusing outward. For example, the first valve is a valve on a pipe section located at a connection between the contamination source region and another pipe network region, and water flow flows from the contamination source region to a downstream region.

The pipe section refers to a pipeline segment connecting two nodes or regions in the pipe network system. For example, the pipe section is a pipeline segment connecting two monitoring points or a pipeline segment connecting different pipe network regions.

In some embodiments, for each contamination source region, the processor determines a plurality of pipe sections through which water flow flows from the contamination source region to other pipe network regions based on a flow direction of water flow in the contamination source region. Then, the processor determines valves in the pipe sections at connections with adjacent other regions as the first valves.

In some embodiments, other factors may also be considered for determining the first valves. For example, topology structure information of the pipe network, state information of a valve (e.g., whether the valve is operable and a last operation time), and an importance level of the valve are combined, so as to optimize a determination process of the first valves.

In step 240, a first valve control instruction is generated based on the plurality of first valves, and the plurality of first valves within the contamination source region are controlled to close based on the first valve control instruction.

The first valve control instruction refers to an instruction configured to control the first valve in the pipe network to perform a specified operation. For example, the first valve control instruction includes an instruction for controlling the first valves within the contamination source region to close.

In some embodiments, after the plurality of first valves are determined, the processor generates the first valve control instruction based on an identifier, a position, and an operation to be performed (e.g., closing) of each of the plurality of first valves. For example, the first valve control instruction is a data packet, and the data packet may include a unique identifier of each first valve, an operation type (e.g., closing), and optional operation parameters (e.g., a closing speed and a closing priority).

In some embodiments, a valve type may also be considered when the first valve control instruction is generated. For example, for an electric valve, the first valve control instruction is directly sending a motor control signal. As another example, for a manual valve, the first valve control instruction is a work order including operation steps and a responsible person.

In some embodiments, the processor sends the first valve control instruction to the emergency water quality object platform. The emergency water quality object platform sends the first valve control instruction to a valve control system (e.g., a valve controller), or the processor directly sends the first valve control instruction to a valve control system in the pipe network. After the valve control system receives the first valve control instruction, the valve control system drives a corresponding first valve to perform a closing operation corresponding to the first valve control instruction.

In some embodiments of the present disclosure, in response to the water quality contamination point occurring within the pipe network region, by combining the contamination probability evaluated in advance for each pipe network region with water quality contamination point information, the critical contamination region and the contamination source region are determined accurately and quickly, so as to improve timeliness and pertinence of determination of the water quality contamination source. The plurality of first valves are determined based on the source hydraulic data of the contamination source region and controlled to close, so that effective isolation and preliminary control of the contamination source region are achieved, a risk of contamination diffusing to other pipe network regions is reduced, and a starting speed and an accuracy of the emergency water quality response are improved.

In some embodiments, the method for emergency water quality management in a smart city pipe network further comprises: determining a plurality of sampling points based on source water quality data of the contamination source region; generating a sampling instruction based on the plurality of sampling points, and controlling an inspection robot to move to the plurality of sampling points for water flow sampling based on the sampling instruction; determining a contamination source based on sampling results sampled by the inspection robot; and generating alert information based on the contamination source, sending the alert information to a user terminal, and controlling the user terminal to display the alert information.

The sampling point refers to a position for performing water sampling. For example, the sampling point includes position coordinates of a water sampling position in the contamination source region.

In some embodiments, the processor determines the plurality of monitoring points within the contamination source region as the sampling points. In some embodiments, the processor analyzes the source water quality data of the plurality of monitoring points within the contamination source region to determine the sampling points. For example, the processor analyzes the source water quality data, identifies a plurality of monitoring points with one or more water quality indexes (e.g., residual chlorine, turbidity, and TOC) being abnormal or exceeding a preset threshold, and determines the plurality of monitoring points as the sampling points.

In some embodiments, determination of the sampling points may be implemented in various other manners. For example, the sampling points are selected based on a distribution pattern of historical contamination events, an important node position of the pipe network, or experience of technical personnel.

In some embodiments, the processor generates the sampling instruction based on the plurality of sampling points, and controls the inspection robot to move to the plurality of sampling points for water flow sampling based on the sampling instruction.

The sampling instruction refers to an instruction configured to control a device or personnel to collect a water flow sample at a specified position. For example, the sampling instruction includes an instruction for controlling the inspection robot to move to the sampling point for water flow sampling.

The inspection robot refers to a robot device configured to automatically or semi-automatically perform tasks such as inspection, monitoring, and sampling in a pipe network environment. For example, the inspection robot includes a robot configured to move in the pipe network and carry water quality sampling equipment.

In some embodiments, the processor determines geographic coordinates or internal identification numbers of the plurality of sampling points, and generates the sampling instruction including the point information. The sampling instruction may further include parameters such as a sampling order, a sampling amount, and a sampling frequency. For example, the sampling instruction is a data packet, and the data packet includes an accurate global positioning system (GPS) coordinate of each sampling point and/or a sampling logical identifier in the pipe network.

In some embodiments, the processor sends the sampling instruction to the inspection robot, and controls the inspection robot to move to the plurality of sampling points for water flow sampling. For example, after receiving the sampling instruction, the inspection robot plans a path based on point information in the sampling instruction through a navigation system of the inspection robot and autonomously moves to each sampling point, and controls a robotic arm or a sampling device carried by the inspection robot to perform water flow sampling.

In some embodiments, in addition to the inspection robot, the processor may further control other automated devices or control personnel to perform water flow sampling based on the sampling instruction, so as to ensure accuracy of water sample acquisition. For example, a fixed automatic sampler is controlled to perform sampling at the preset time.

In some embodiments, the processor determines the contamination source based on the sampling results sampled by the inspection robot.

The sampling result refers to a plurality of indicators and a plurality of pieces of data obtained after analyzing a collected water sample. For example, the sampling result includes contents of a plurality of contaminant components in water flow, such as a microbial contaminant component, a chemical contaminant component, a physical contaminant component, or the like. The microbial contaminant component includes a pathogenic bacterium (e.g., Escherichia coli or Salmonella), a virus, a parasite, or the like. The chemical contaminant component includes a heavy metal (e.g., lead or cadmium), petroleum and a derivative of petroleum, a nitrate, a cyanide, or the like. The physical contaminant component includes suspended solids such as silt and clay.

In some embodiments, the processor analyzes the water sample to determine the sampling result. Analysis methods include, but are not limited to, an enzyme substrate method, a membrane filtration method, an inductively coupled plasma mass spectrometry method, and a liquid-liquid extraction method and/or a solid-phase extraction method.

The contamination source refers to a cause resulting in contamination in the pipe network. For example, the contamination source includes backflow of an external water body (e.g., backflow of chemical plant waste) and internal contamination caused by pipeline corrosion.

In some embodiments, the processor determines the contamination source through querying a second preset table based on categories and contents of contaminant components in the sampling result.

In some embodiments, the second preset table stores an association relationship between a plurality of types of contaminant components and contents and a predefined contamination source. The second preset table may be set by technical personnel based on experience, or generated by training the machine learning model. For example, in the second preset table, a contaminant component being Escherichia coli at a high content corresponds to the contamination source of backflow of external domestic waste; a contaminant component being a heavy metal with a content lower than a preset content corresponds to the contamination source of pipeline corrosion; and a contaminant component being a heavy metal with a content greater than or equal to the preset content corresponds to the contamination source of backflow of external chemical waste. The preset content is determined based on experience or simulation experiments.

In some embodiments, determining the contamination source may also be implemented in other manners. For example, historical data, simulation results, and an expert experience system are combined for comprehensive determination, so as to more accurately identify a root cause of contamination.

In some embodiments, the processor generates the alert information based on the contamination source, sends the alert information to the user terminal, and controls the user terminal to display the alert information.

The alert information refers to information configured to provide an alert and a reminder of a source and a position of water quality contamination. For example, the alert information includes a cause resulting in contamination and a position of the contamination source region.

More descriptions regarding the user terminal may be found in other contents of the present disclosure (e.g., descriptions in connection with FIG. 1).

In some embodiments, the processor integrates the determined contamination source and position information of the contamination source region into a message body to generate the alert information. For example, the alert information is a structured data packet, and the structured data packet includes a contaminant component type, a map coordinate or a region name of the contamination source region, and a suggested handling measure.

In some embodiments, the processor sends the alert information to the user terminal, and controls the user terminal to display the alert information. The user terminal may display the alert information in various manners. For example, the user terminal plays an alert voice, performs vibration, pops up a text message, or highlights the contamination source region on a map and marks the contamination source.

In some embodiments of the present disclosure, by determining the sampling points and dispatching the inspection robot to perform fixed-point physical sampling, and performing detailed analysis on the sampling result to determine the contamination source, accurate verification of the contamination source is achieved. The method avoids a limitation of only relying on real-time monitoring data for preliminary determination, provides a more reliable basis for contamination traceability, and avoids inconvenience and inefficiency of manual sampling, so as to effectively improve efficiency and accuracy of pipe network water quality management and emergency response.

In some embodiments, the method for the emergency water quality management in the smart city pipe network further comprises: determining a water source site corresponding to the contamination source region based on the source hydraulic data of the contamination source region and the pipe network data; determining a plurality of flushing paths based on the contamination probability of the one or more pipe network regions and the water source site corresponding to the contamination source region; and generating a flushing instruction based on the flushing paths, and controlling a drain valve on each of flushing paths to open and controlling a pipe flushing device to perform flushing based on the flushing instruction.

More descriptions regarding the contamination source region, the source hydraulic data, and the pipe network data may be found in the related descriptions of step 220.

The water source site refers to a water supply source of the contamination source region. For example, the water source site includes a water plant configured to supply water to the contamination source region.

In some embodiments, the processor determines an upstream region of the contamination source region step by step based on the source hydraulic data (e.g., a flow direction) in the contamination source region and in combination with the pipe network data (e.g., a connection relationship and a trend). The processor repeats the process of determining the upstream region until the water source site of the pipe network system is traced.

In some embodiments, the processor may further determine the water source site of the contamination source region by simulating a propagation path of water flow in the pipe network through a trained machine learning model (e.g., a model based on a graph neural network (GNN)).

More descriptions regarding the pipe network region and the contamination probability may be found in the related descriptions of step 210.

The flushing paths refers to a plurality of pipelines to be flushed and a flow direction of a flushing fluid.

In some embodiments, for each contamination source region, the processor determines a plurality of candidate paths between the contamination source region and the water source site corresponding to the contamination source region through a path planning algorithm. The path planning algorithm may include a breadth-first search (BFS) algorithm, Yen's algorithm, etc. In some embodiments, the processor may evaluate the plurality of candidate paths based on the contamination probability to determine the flushing path. For example, an average value of contamination probabilities of a plurality of pipe network regions through which each candidate path passes is determined, and a candidate path with a highest mean value of contamination probabilities is selected as the flushing path for flushing the contamination source region.

In some embodiments, a manner of determining the plurality of flushing paths may further include, but is not limited to, screening and determining paths based on factors such as a path length, a hydraulic resistance, the pipe material data, and a historical flushing effect, or the like.

The flushing instruction refers to an instruction configured to control the pipe flushing device to perform a pipe flushing operation. For example, the flushing instruction includes controlling the drain valve on each of the flushing path to open or controlling the pipe flushing device to perform flushing. The flushing instruction may include a unique identifier of the flushing path, a list of the drain valves to be operated on the flushing path and an operation sequence of the drain valves, and flushing parameters of the pipe flushing device (e.g., a flushing pressure, a flushing time, a flushing flow rate, or the like).

The drain valve refers to a valve configured to discharge contaminated water in the pipe network or other contaminants. The drain valve may be arranged at a low point or an end of the pipe network.

The pipe flushing device refers to a device configured to perform physical flushing on a pipeline in the pipe network so as to remove deposits or contaminants. For example, the pipe flushing device includes a high-pressure water flushing device or a mechanical pigging device. The pipe flushing device may be fixedly installed at a specified position of a pipeline, or the pipe flushing device may be movable. For example, the pipe flushing device is arranged on a movable robot.

In some embodiments, the processor analyzes, based on the flushing path, a unique identifier of a pipeline corresponding to the flushing path in the pipe network, the identifier of the corresponding drain valve, an identifier of the pipe flushing device, a connection sequence of the pipeline in the pipe network, an arrangement sequence of the pipeline in the pipe network, or the like, and generates the flushing instruction.

In some embodiments, the processor controls the drain valve on each of the flushing path to open based on the flushing instruction.

In some embodiments, the processor controls the pipe flushing device to perform flushing based on the flushing instruction. For example, the flushing instruction is sent to a high-pressure water flushing device or a mechanical pigging device, so that the high-pressure water flushing device or the mechanical pigging device performs physical flushing on a pipeline on the flushing path according to the flushing parameters. The flushing parameters may be preset based on experience according to a contamination severity. As another example, the flushing instruction is sent to a movable robot carrying the pipe flushing device, and the movable robot is controlled to move to a corresponding pipeline, and the pipe flushing device is controlled to perform flushing according to the flushing parameters.

In some embodiments, execution of the flushing instruction may also be linked with the water quality monitoring data. During flushing, water quality of discharged water is monitored in real time. In response to determining that the water quality reaches a preset cleanliness standard, the drain valve is automatically closed and flushing is stopped.

In some embodiments of the present disclosure, by determining the water source site corresponding to the contamination source region based on the source hydraulic data of the contamination source region and the pipe network data, and determining the plurality of flushing paths in combination with the contamination probability of the pipe network region, the flushing instruction is generated and the drain valve is controlled to open and the pipe flushing device is controlled to perform flushing, so that contaminated water in the pipe network is removed physically in a targeted and efficient manner, and recovery of pipe network water quality is accelerated.

In some embodiments, the method for emergency water quality management in a smart city pipe network further comprises: generating a disinfection instruction based on the source water quality data of the contamination source region, wherein the disinfection instruction comprises a disinfectant dosage and a disinfection power; and controlling a disinfection device at the water source site to perform disinfection at the disinfection power and dispensing a disinfectant in the disinfectant dosage based on the disinfection instruction.

The disinfection instruction refers to an instruction configured to control a related device or system to perform a water body disinfection operation. For example, the disinfection instruction includes parameters such as the disinfectant dosage and the disinfection power.

The disinfectant dosage refers to a dosage of a disinfectant to be dispensed during a water body disinfection process. For example, the disinfectant dosage is a dosage of liquid chlorine or another disinfectant.

The disinfection power refers to a power parameter during operation of the disinfection device. For example, the disinfection power is an operating power of an ultraviolet disinfector.

In some embodiments, for each contamination source region, the processor queries a third preset table based on an average value of water quality indexes in the source water quality data of a plurality of monitoring points within the contamination source region, so as to determine the disinfectant dosage and the disinfection power corresponding to the contamination source region. The third preset table stores in advance a plurality of sets of average values of water quality indexes (e.g., an average value of residual chlorine content, an average value of turbidity, and an average value of TOC) and a mapping relationship between the plurality of sets of average values and the disinfectant dosage and the disinfection power. The third preset table may be set based on experience or simulation results.

In some embodiments, the disinfection instruction may also be generated in other manners. For example, a water body temperature and a pH value are further considered.

In some embodiments, the processor controls the disinfection device at the water source site to operate at the disinfection power based on the disinfection instruction, and dispenses the disinfectant in the disinfectant dosage.

The disinfectant includes liquid chlorine, sodium hypochlorite, chlorine dioxide, ozone, or the like.

In some embodiments, a control manner of the disinfection device may further include other manners. For example, the control manner of the disinfection device includes remote automation control, local manual intervention adjustment, or linkage control with another water treatment device.

In some embodiments of the present disclosure, the disinfection instruction including the disinfectant dosage and the disinfection power is generated based on real-time water quality data of the contamination source region, and the disinfection device at the water source site is parametrically controlled based on the disinfection instruction. In combination with pipe flushing, enhanced disinfection of a water body at the water source site is synchronously implemented. By combining pipe flushing with disinfection, thoroughness of handling pipe network water quality contamination is improved, harmful substances such as microorganisms potentially brought by the contamination source are effectively killed or inhibited, and a risk of contamination diffusion is reduced.

FIG. 3 is a schematic diagram illustrating an exemplary process for determining a contamination source region and one or more future diffusion paths based on a hydraulic model according to some embodiments of the present disclosure.

In some embodiments, the processor constructs the hydraulic graph based on the water quality monitoring data, the hydraulic monitoring data, and the pipe network data of the plurality of monitoring points; and determines the contamination source region based on the hydraulic graph through the hydraulic model.

As shown in FIG. 3, an input of the hydraulic model 320 includes the hydraulic graph 310, and an output of the hydraulic model 320 includes the contamination source region 330.

The hydraulic model 320 may be a machine learning model or a neural network model. For example, the hydraulic model 320 includes, but is not limited to, a deep neural network (DNN) model, a graph neural network (GNN) model, or the like.

The hydraulic graph refers to a graph structure reflecting a pipe network topology structure and related hydraulic characteristics and water quality characteristics. The hydraulic graph includes nodes and edges.

In some embodiments, the processor constructs the hydraulic graph based on the water quality monitoring data, the hydraulic monitoring data, and the pipe network data of the plurality of monitoring points. In some embodiments, the processor abstracts pipeline connection points in the pipe network data and/or monitoring points of a pipe network region as nodes of the hydraulic graph, and abstracts pipelines connecting nodes as edges of the hydraulic graph.

A node feature includes the water quality monitoring data and whether a node is within the critical contamination region. An edge represents a pipeline connection relationship, and an edge feature includes a flow velocity of water flow in the hydraulic monitoring data. The edge is a directed edge, and the edge points from an upstream node connected by the edge to a downstream node connected by the edge.

In some embodiments, the edge feature of the hydraulic graph further includes the static anomaly index of the one or more pipe network regions.

For example, for each edge, the processor determines the static anomaly index of the pipe network pipeline corresponding to the edge in the pipe network region as the edge feature. More descriptions regarding the static anomaly index may be found elsewhere in the present disclosure (e.g., FIG. 2 and related descriptions thereof).

In some embodiments of the present disclosure, by using a physical contamination risk of a pipeline ( the static anomaly index) as the edge feature of the hydraulic graph, the hydraulic model, when performing traceability and prediction, integrates dynamic information of water flow and a static health condition of the pipeline, so as to improve accuracy of an analysis result.

In some embodiments, in order to more accurately reflect pipe network dynamics, construction of the hydraulic graph is a dynamic process. For example, the processor periodically updates the node feature, the edge feature, and even a topology structure of the hydraulic graph based on latest water quality monitoring data, hydraulic monitoring data, and pipe network data.

In some embodiments, the hydraulic model is obtained by training based on first training samples and first labels. The first training samples include a plurality of historical hydraulic graphs of different pipe networks when historical water quality contamination occurs. The plurality of historical hydraulic graphs reflect a pipe network structure, water quality states, and hydraulic states when contamination occurs. The first labels include a plurality of actual contamination source regions in the historical water quality contamination corresponding to the first training samples.

In some embodiments, the first label may be determined from the actual contamination source regions obtained from manual purification records of pipe network regions.

In some embodiments, the hydraulic model may be trained through a gradient descent method, or the like. A training process includes: inputting the first training sample into the initial hydraulic model, and obtaining the initial contamination source region; determining the loss function based on the initial contamination source region and the first label; iteratively updating parameters of the initial hydraulic model by using the loss function; and in response to a preset condition being satisfied, obtaining the trained hydraulic model. The preset condition includes convergence of the loss function or the iteration reaching a maximum count.

In some embodiments of the present disclosure, by constructing the hydraulic graph and applying the hydraulic model for analysis, the hydraulic graph is enabled to comprehensively represent water quality information, hydraulic information, and topology structure information of the pipe network, so as to provide a rich and structured data basis for contamination traceability. By using the machine learning model, complex association patterns of nodes and edges in the hydraulic graph are deeply mined, so that a potential contamination source region is effectively identified, and efficiency and accuracy of contamination traceability are improved.

In some embodiments, the processor determines the one or more future diffusion paths based on the hydraulic graph through the hydraulic model; determines a block valve group based on the one or more future diffusion paths; and generates a second valve control instruction based on the block valve group, and controls valves within the block valve group to close based on the second valve control instruction.

As shown in FIG. 3, the output of the hydraulic model 320 further includes the one or more future diffusion paths 340.

The future diffusion path refers to a path along which water quality contamination in the critical contamination region or the contamination source region diffuses to another region. For example, the future diffusion path includes a downstream pipeline connected with the critical contamination region or the contamination source region.

In some embodiments, in response to an output of the hydraulic model including the future diffusion path, the first label further includes a sample diffusion path corresponding to the first training sample. The sample diffusion path is determined based on an actual diffusion path corresponding to the first training sample in an actual pipe network water quality management record. The sample diffusion path is also determined through a simulation experiment.

In some embodiments, the processor further predicts the future diffusion path in a plurality of other manners. For example, the future diffusion path is predicted by using a conventional numerical simulation method, a regression analysis model, or another prediction algorithm.

The block valve group refers to a set of a plurality of valves configured to cut off the one or more future diffusion paths.

In some embodiments, the processor identifies key valves located on the one or more future diffusion paths and capable of effectively preventing contaminated water from further spreading downstream, and determines the key valves as the block valve group. For example, the processor traces each branch point and each region boundary on the one or more future diffusion paths, determines downstream valves located at the branch points and the region boundaries, and incorporates the downstream valves into the block valve group.

In some embodiments, the processor determines a plurality of sets of candidate block valve groups based on the one or more future diffusion paths; determines a blocking effect of each of the plurality of sets of candidate block valve groups based on the hydraulic graph through a loss assessment model; and determines the block valve group based on the blocking effect.

The candidate block valve group refers to an alternative block valve group as a candidate for a final block valve group.

In some embodiments, the processor classifies key valves on the one or more future diffusion paths determined above, so as to determine a plurality of sets of candidate block valve groups. For example, according to the connection relationships of the pipe network in the pipe network data, the key valves are classified based on a distance level between each key valve and the contamination source region: a key valve connected to the contamination source region by only one pipe section is determined as a first candidate valve group, a key valve connected to the contamination source region by two pipe sections is determined as a second candidate valve group, and so on.

In some embodiments, for the one or more predicted future diffusion paths, the processor identifies all valves located on the one or more predicted future diffusion paths or closely related to the one or more predicted future diffusion paths. Then, the processor randomly generates different valve combinations based on the valves, so as to determine a plurality of sets of candidate block valve groups.

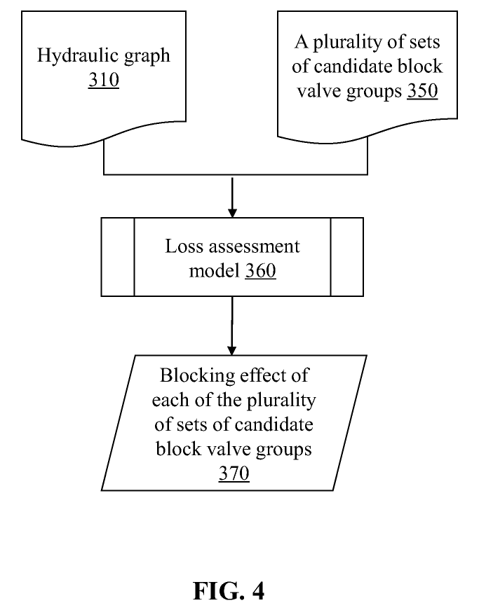

In some embodiments, as shown in FIG. 4, the processor inputs the hydraulic graph 310 and the plurality of sets of candidate block valve groups 350 into the loss assessment model 360, so as to determine the blocking effect 370 of each of the plurality of sets of candidate block valve groups.

The loss assessment model 360 refers to a model configured to evaluate the blocking effect of the candidate block valve group. For example, the loss assessment model may be a machine learning model, a neural network model (e.g., a graph neural network), or the like.

The blocking effect refers to a blocking degree, an effect, and an impact on diffusion of water quality contamination. For example, the blocking effect includes a contamination inhibition effect (e.g., reduction of a contamination diffusion range) and a loss caused by blocking (e.g., a count of closed valves and a water outage range). The blocking effect may be represented by a score, such as 9.8 points, 6.5 points, etc.

In some embodiments, the loss assessment model is obtained by training based on second training samples and second labels.

The second training samples includes a plurality of historical hydraulic graphs of different regions when historical water quality contamination occurs and the used historical block valve group.

The second labels include a historical loss actually caused and a historical contamination inhibition effect after blocking is performed by using the historical block valve group. The second label is determined by normalizing the historical loss actually caused and the historical contamination inhibition effect and then performing weighted summation. Weighting coefficients for weighted summation are set by default by the system or set manually, and a weighting coefficient corresponding to the historical loss is a negative value.

In some embodiments, after the blocking effect of each of the plurality of sets of candidate block valve groups is obtained, the processor determines a candidate block valve group with a best blocking effect among the plurality of sets of candidate block valve groups or a candidate block valve group with a blocking effect exceeding a blocking effect threshold as the block valve group. The best blocking effect means that contamination diffusion is inhibited to a maximum extent while an associated loss is minimized.

In some embodiments of the present disclosure, by determining the plurality of sets of candidate block valve groups based on the one or more predicted future diffusion paths and evaluating, through the loss assessment model, the blocking effect of each of the plurality of sets of candidate block valve groups in an accurate and quantitative manner, the block valve group with the optimal comprehensive blocking effect is intelligently selected based on the evaluation results, so that on the premise of ensuring effective blocking of water quality contamination, social and economic costs caused by blocking operations are reduced.

In some embodiments, the block valve group may also be determined through other strategies. For example, the block valve group is determined based on a physical position of a valve, a pipe network topology structure, historical valve operation data, or an intelligent optimization algorithm.

The second valve control instruction refers to an instruction configured to control the block valve group in the pipe network to perform a specified blocking operation. For example, the second valve control instruction includes an instruction for controlling valves within the block valve group to close.

In some embodiments, the processor encapsulates an identifier of each block valve in the block valve group and a corresponding “close” operation into a data packet, so as to form the second valve control instruction.

In some embodiments, the processor sends the generated second valve control instruction to a valve controller corresponding to each valve within the block valve group. After the valve controller receives the second valve control instruction, the valve controller drives an actuator of the valve to close the valve.

In some embodiments of the present disclosure, by predicting the one or more future diffusion paths of water quality contamination in the pipe network through the hydraulic model and determining the block valve group to be closed accordingly, precise containment of contaminated water is achieved, further expansion of a contamination range is effectively prevented, and efficiency of pipe network water quality management and response capability for handling a sudden contamination event are improved.

In some embodiments of the present disclosure further provide a non-transitory computer-readable storage medium, and the computer-readable storage medium stores computer instructions. In response to a computer reading the computer instructions stored in the computer-readable storage medium, the computer performs the method for the emergency water quality management in the smart city pipe network in the above embodiments.

In some embodiments of the present disclosure further provide a smart city pipe network emergency water quality device, and the smart city pipe network emergency water quality device includes a memory and a processor, wherein the processor is configured to perform the method for the emergency water quality management in the smart city pipe network described in the above embodiments.

The foregoing descriptions of the basic concepts are illustrative. For a person skilled in the art, the foregoing detailed disclosure is presented by way of example only and does not limit the present disclosure. Although not explicitly stated herein, various modifications, improvements, and amendments to the present disclosure may be made by a person skilled in the art. Such modifications, improvements, and amendments are suggested in the present disclosure. Therefore, such modifications, improvements, and amendments still fall within the scope of the exemplary embodiments of the present disclosure.

Furthermore, certain features, structures, or characteristics of one or more embodiments of the present disclosure may be appropriately combined.

Accordingly, in some embodiments, numerical parameters used in the specification and claims are approximate values. The approximate values may vary according to characteristics required by individual embodiments. In some embodiments, the numerical parameters should consider a prescribed number of significant digits and adopt a general method of digit retention. Although numerical ranges and parameters used to confirm a breadth of a range in some embodiments of the present disclosure are approximate values, in specific embodiments, setting of such values is as precise as possible within a feasible range.

If descriptions, definitions, and/or use of terms in cited materials are inconsistent or conflict with the content described in the present disclosure, the descriptions, definitions, and/or use of terms in the present disclosure prevail.

What is claimed is:

1. A system for emergency water quality management in a smart city pipe network based on an Internet of Things large model, comprising an emergency water quality management platform, wherein the emergency water quality management platform is configured to:
in response to a water quality contamination point occurring within one or more pipe network regions, determine a critical contamination region based on a contamination probability of the one or more pipe network regions and the water quality contamination point;
determine a contamination source region based on water quality monitoring data, hydraulic monitoring data, and pipe network data of a plurality of monitoring points within the critical contamination region;
determine a plurality of first valves based on source hydraulic data of the contamination source region, wherein the plurality of first valves are downstream valves on pipe sections at connections between the contamination source region and other pipe network regions; and
generate a first valve control instruction based on the plurality of first valves, and control the plurality of first valves within the contamination source region to close based on the first valve control instruction.

2. The system of claim 1, wherein the emergency water quality management platform is further configured to:
determine a plurality of sampling points based on source water quality data of the contamination source region;
generate a sampling instruction based on the plurality of sampling points, and control an inspection robot to move to the plurality of sampling points for water flow sampling based on the sampling instruction;
determine a contamination source based on sampling results sampled by the inspection robot; and
generate alert information based on the contamination source, send the alert information to a user terminal, and control the user terminal to display the alert information.

3. The system of claim 1, wherein the emergency water quality management platform is further configured to:
determine a water source site corresponding to the contamination source region based on the source hydraulic data of the contamination source region and the pipe network data;
determine a plurality of flushing paths based on the contamination probability of the one or more pipe network regions and the water source site corresponding to the contamination source region; and
generate a flushing instruction based on the flushing paths, and control a drain valve on each of the flushing paths to open and control a pipe flushing device to perform flushing based on the flushing instruction.

4. The system of claim 3, wherein the emergency water quality management platform is further configured to:
generate a disinfection instruction based on the source water quality data of the contamination source region, wherein the disinfection instruction comprises a disinfectant dosage and a disinfection power; and
control a disinfection device at the water source site to perform disinfection at the disinfection power and dispense a disinfectant in the disinfectant dosage based on the disinfection instruction.

5. The system of claim 1, wherein the emergency water quality management platform is further configured to:
at each preset interval,
obtain a water quality data sequence of the one or more pipe network regions in the pipe network; and
determine the contamination probability of the one or more pipe network regions based on the water quality data sequence and pipe material data.

6. The system of claim 5, wherein the emergency water quality management platform is further configured to:
determine a dynamic anomaly index and a static anomaly index of the one or more pipe network regions based on the water quality data sequence and the pipe material data; and
determine the contamination probability of the one or more pipe network regions based on the dynamic anomaly index and the static anomaly index.

7. The system of claim 1, wherein the emergency water quality management platform is further configured to:
construct a hydraulic graph based on the water quality monitoring data, the hydraulic monitoring data, and the pipe network data of the plurality of monitoring points; and
determine the contamination source region based on the hydraulic graph through a hydraulic model, wherein the hydraulic model is a machine learning model.

8. The system of claim 7, wherein an edge feature of the hydraulic graph includes a static anomaly index of the one or more pipe network regions.

9. The system of claim 7, wherein the emergency water quality management platform is further configured to:
determine one or more future diffusion paths based on the hydraulic graph through the hydraulic model;
determine a block valve group based on the one or more future diffusion paths; and
generate a second valve control instruction based on the block valve group, and control valves within the block valve group to close based on the second valve control instruction.

10. The system of claim 9, wherein the emergency water quality management platform is further configured to:
determine a plurality of sets of candidate block valve groups based on the one or more future diffusion paths;
determine a blocking effect of each of the plurality of sets of candidate block valve groups based on the hydraulic graph through a loss assessment model; and
determine the block valve group based on the blocking effect.

11. A method for emergency water quality management in a smart city pipe network, wherein the method is implemented by an emergency water quality management platform of a system for emergency water quality management in a smart city pipe network based on an Internet of Things large model, and the method comprises:
in response to a water quality contamination point occurring within one or more pipe network regions, determining a critical contamination region based on a contamination probability of the one or more pipe network regions and the water quality contamination point;
determining a contamination source region based on water quality monitoring data, hydraulic monitoring data, and pipe network data of a plurality of monitoring points within the critical contamination region;
determining a plurality of first valves based on source hydraulic data of the contamination source region, wherein the plurality of first valves are downstream valves on pipe sections at connections between the contamination source region and other pipe network regions; and
generating a first valve control instruction based on the plurality of first valves, and controlling the plurality of first valves within the contamination source region to close based on the first valve control instruction.

12. The method of claim 11, wherein the method further comprises:
determining a plurality of sampling points based on source water quality data of the contamination source region;
generating a sampling instruction based on the plurality of sampling points, and controlling an inspection robot to move to the plurality of sampling points for water flow sampling based on the sampling instruction;
determining a contamination source based on sampling results sampled by the inspection robot; and
generating alert information based on the contamination source, sending the alert information to a user terminal, and controlling the user terminal to display the alert information.

13. The method of claim 11, wherein the method further comprises:
determining a water source site corresponding to the contamination source region based on the source hydraulic data of the contamination source region and the pipe network data;
determining a plurality of flushing paths based on the contamination probability of the one or more pipe network regions and the water source site corresponding to the contamination source region; and
generating a flushing instruction based on the flushing paths, and controlling a drain valve on each of the flushing paths to open and controlling a pipe flushing device to perform flushing based on the flushing instruction.

14. The method of claim 11, wherein the method further comprises:
generating a disinfection instruction based on the source water quality data of the contamination source region, wherein the disinfection instruction comprises a disinfectant dosage and a disinfection power; and
controlling a disinfection device at the water source site to perform disinfection at the disinfection power and dispensing a disinfectant in the disinfectant dosage based on the disinfection instruction.

15. The method of claim 11, wherein the contamination probability is determined by a process comprising:
at each preset interval,
obtaining a water quality data sequence of the one or more pipe network regions in the pipe network; and
determining the contamination probability of the one or more pipe network regions based on the water quality data sequence and pipe material data.

16. The method of claim 15, wherein determining the contamination probability of the one or more pipe network regions based on the water quality data sequence and pipe material data comprises:
determining a dynamic anomaly index and a static anomaly index of the one or more pipe network regions based on the water quality data sequence and the pipe material data; and
determining the contamination probability of the one or more pipe network regions based on the dynamic anomaly index and the static anomaly index.

17. The method of claim 11, wherein determining a contamination source region based on water quality monitoring data, hydraulic monitoring data, and pipe network data of a plurality of monitoring points within the critical contamination region comprises:
constructing a hydraulic graph based on the water quality monitoring data, the hydraulic monitoring data, and the pipe network data of the plurality of monitoring points; and
determining the contamination source region based on the hydraulic graph through a hydraulic model, wherein the hydraulic model is a machine learning model.

18. The method of claim 17, further comprising:
determining one or more future diffusion paths based on the hydraulic graph through the hydraulic model;
determining a block valve group based on the one or more future diffusion paths; and
generating a second valve control instruction based on the block valve group, and controlling valves within the block valve group to close based on the second valve control instruction.

19. The method of claim 18, further comprising:
determining a plurality of sets of candidate block valve groups based on the one or more future diffusion paths;
determining a blocking effect of each of the plurality of sets of candidate block valve groups based on the hydraulic graph through a loss assessment model; and
determining the block valve group based on the blocking effect.

20. A non-transitory computer-readable storage medium, storing computer instructions, wherein when a computer reads the computer instructions stored in the non-transitory computer-
readable storage medium, the computer is configured to perform the method of claim 11.
